(19) United States
(12) Patent Application Publication
(10) Pub. No.: US 2026/0267310 A1
(43) Pub. Date: Sep. 10, 2026

(54) POSITIONING DEVICE

(71) Applicant: TORAY ENGINEERING CO., LTD., Tokyo (JP)

(72) Inventors: Satoru NARABA, Otsu-shi, Shiga (JP); Katsumi TERADA, Otsu-shi, Shiga (JP)

(21) Appl. No.: 19/166,119

(22) PCT Filed: Mar. 15, 2024
(86) PCT No.: PCT/JP2024/010138

§ 371 Date: Sep. 17, 2025

(30) Foreign Application Priority Data
Mar. 28, 2023 (JP) 2023-052123

(51) Int. Cl. G05B 19/402; G01D 5/347; G01D 18/00

(52) U.S. Cl. CPC G05B 19/402; G01D 5/34715; G01D 18/001; G05B 2219/31304

(57) ABSTRACT

A positioning device includes a target object moving unit, a target object position measuring unit and a control unit. The control unit outputs a calibrated position control signal obtained by calibrating a position control signal using an addition-side provisional calibration value, and acquires an addition-side calibration measurement position. The control unit outputs a calibrated position control signal obtained by calibrating the position control signal using a subtraction-side provisional calibration value, and acquires a subtraction-side calibration measurement position. The control unit sets, as a new reference calibration value, a provisional calibration value used for calculation of a calibrated position control signal that moved the target object to a calibration measurement position that has a smaller difference from the target position, from among the addition-side calibration measurement position and the subtraction-side calibration measurement position.

### CROSS REFERENCES TO RELATED APPLICATIONS

This application is a U.S. National stage of International Application No. PCT/JP2024/010138, filed on Mar. 15, 2024. This application claims priority to Japanese Patent Application No. 2023-052123 filed on Mar. 28, 2023 with Japan Patent Office.

### BACKGROUND

### Field of the Invention

The present invention generally relates to a positioning device for positioning a target object.

### Background Information

A manufacturing apparatus such as a semiconductor manufacturing apparatus or an inkjet coating apparatus has a stage on which a substrate, etc., is placed, a bonder device for connecting an IC chip to the substrate, etc., and a processing device such as a coating device that applies ink, or the like. The manufacturing apparatus is configured to be capable of moving the stage or the processing device to a given position using a positioning device that relatively positions the processing device with respect to a substrate, etc., on the stage. The positioning device has an actuator the moves the stage or the processing device, and a control device that controls the actuator. In addition, the actuator has a measuring device that measures the position of the stage or the processing device. The positioning device moves the stage or the processing device to a target position on the basis of a measurement signal from the measuring device.

Such a positioning device is required to have high positional accuracy of several μm or less. On the other hand, in a positioning device, the positioning position deviates from the command value due to variation in the accuracy of the actuator, age deterioration caused by wear, etc., of mechanical parts, thermal expansion or contraction of component members caused by environmental temperature, and the like. Therefore, the manufacturing apparatus may not be able to carry out positioning with prescribed accuracy, even if the stage or the processing device is moved to the target position on the basis of a measured value of the measuring device. Therefore, calibration methods are known for suppressing deviation in the positioning position that occur due to variation in the accuracy of the actuator, age deterioration caused by wear, etc., of mechanical parts, thermal expansion or contraction of component members caused by environmental temperature, and the like.

The component mounting device disclosed in Japanese Laid-Open Patent Application Publication No. 2008-227047 (Patent Literature 1) mounts a component picked up by a mounting head onto a substrate positioned at a prescribed position. The component mounting device described above comprises a positioning means that positions a calibration substrate at a prescribed position, a calibration component mounting means that mounts a calibration component picked up by the mounting head on a target mounting position on the calibration substrate on the basis of control data, and a calibration means that detects misalignment between the target mounting position and the actual mounting position of the calibration component mounted on the calibration substrate to calibrate the control data. The component mounting device uses the calibration substrate and the calibration component to calibrate the control data on the basis of the misalignment between the mounting position and the target mounting position of the calibration component with respect to the calibration substrate.

### SUMMARY

The positioning accuracy of the component mounting device disclosed in Patent Literature 1 is affected by the accuracy of calibration using the calibration substrate and the calibration component. Thus, calibration of the component mounting device requires a higher calibration accuracy than the positioning accuracy required when mounting a component on a substrate. On the other hand, the component mounting device needs to increase the positioning accuracy of the component with respect to the substrate in order to mount miniaturized components at target positions on the substrate. Thus, as the required positioning accuracy increases, there are cases in which the component mounting device cannot achieve the required positioning accuracy due to the effect of errors in the calibration.

An object of the present disclosure is to provide a positioning device that can suppress the effect of calibration errors on the positioning accuracy.

The present inventor investigated configurations of positioning devices that can suppress calibration errors and increase positioning accuracy. As a result of extensive investigation, the present inventor conceived of the following configuration.

The positioning device according to an embodiment of the present disclosure is a positioning device comprising a target object moving unit that has at least one electric actuator and that can move a target object using the electric actuator, a target object position measuring unit that measures the moved position of the target object, and a control unit that outputs, to the target object moving unit, a position control signal for moving the target object to a target position and acquires a measured position of the target object measured by the target object position measuring unit.

The control unit carries out a first calibration control for calculating a reference calibration value of the position control signal on the basis of the target position and the measured position. In addition, the control unit outputs, to the target object moving unit, a calibrated position control signal obtained by calibrating the position control signal using an addition-side provisional calibration value obtained by adding a prescribed value to the reference calibration value, and acquires, from the target object position measuring unit, an addition-side calibration measurement position obtained by measuring the moved position of the target object moved by the target object moving unit on the basis of the calibrated position control signal. The control unit outputs, to the target object moving unit, a calibrated position control signal obtained by calibrating the position control signal using a subtraction-side provisional calibration value obtained by subtracting a prescribed value from the reference calibration value, and acquires, from the target object position measuring unit, a subtraction-side calibration measurement position obtained by measuring the moved position of the target object moved by the target object moving unit on the basis of the calibrated position control signal. Furthermore, the control unit selects, from the addition-side calibration measurement position and the subtraction-side calibration measurement position, the calibration measurement position that has a smaller difference from the target position, and sets, as a new reference calibration value, a provisional calibration value used for calculation of a calibrated position control signal that moved the target object to the selected calibration measurement position.

In the configuration described above, the positioning device executes a first calibration control for determining a reference calibration value, and a second calibration control for calculating a new reference calibration value. In the second calibration control, the positioning device compares the difference between a target position and an addition-side calibration measurement position of a target object that is moved on the basis of a calibrated position control signal calibrated by an addition-side provisional calibration value, with the difference between the target position and a subtraction-side calibration measurement position of the target object that is moved on the basis of a calibrated position control signal calibrated by a subtraction-side provisional calibration value, thereby clarifying the relationship between a reference calibration value and a true calibration value that matches a measured position to the target position. Thus, the positioning device can select, from the addition-side provisional calibration value and the subtraction-side provisional calibration value, the provisional calibration value used for calculation of a calibrated position control signal that brings the measured position closer to the target position, as a new reference calibration value to reduce the calibration error. It is thereby possible to suppress the effect of calibration errors on the positioning accuracy, without using an electric actuator or a target object position measuring unit having higher accuracy.

According to another aspect, the positioning device of the present disclosure preferably includes the following configuration. If the difference between the addition-side calibration measurement position and the target position or the difference between the subtraction-side calibration measurement position and the target position is not included in a prescribed range in the second calibration control, the control unit carries out the second calibration control on the basis of the new reference calibration value set in the second calibration control.

In the configuration described above, the control unit carries out the second calibration control until the difference between the target position and the subtraction-side calibration measurement position based on the subtraction-side provisional calibration value and/or the difference between target position and the addition-side calibration measurement position based on the addition-side provisional calibration value calculated in the second calibration control, falls within a prescribed range. Therefore, the positioning accuracy using the new reference calibration value set in the second calibration control is maintained at or above a prescribed accuracy. It is thereby possible to suppress the effect of calibration errors on the positioning accuracy, without using an electric actuator or a target object position measuring unit having higher accuracy.

According to another aspect, the positioning device of the present disclosure preferably includes the following configuration. The control unit respectively outputs, to the target object moving unit, a plurality of calibrated position control signals obtained by calibrating the position control signal using a plurality of different addition-side provisional calibration values, and acquires, from the target object position measuring unit, a plurality of addition-side calibration measurement positions obtained by measuring the respective moved position of the target object moved by the target object moving unit. The control unit respectively outputs, to the target object moving unit, calibrated position control signals obtained by calibrating the position control signal using a plurality of different subtraction-side provisional calibration values, and acquires, from the target object position measuring unit, a plurality of subtraction-side calibration measurement positions obtained by measuring the respective moved position of the target object moved by the target object moving unit. Furthermore, the control unit sets, as a new reference calibration value, a provisional calibration value used for calculation of a calibrated position control signal that moved the target object to the calibration measurement position that has the smallest difference from the target position, from among the plurality of addition-side calibration measurement positions and the plurality of subtraction-side calibration measurement positions.

In the configuration described above, the control unit calculates the difference between the target position and a plurality of subtraction-side calibration measurement positions and the difference between the target position and a plurality of addition-side calibration measurement positions, moved on the basis of a plurality of calibrated position control signals calibrated by a plurality of preset provisional calibration values; therefore, even if there is a plurality of true calibration values, an appropriate calibration value can be set as the reference calibration value. It is thereby possible to suppress the effect of calibration errors on the positioning accuracy, without using an electric actuator or a target object position measuring unit having higher accuracy.

According to another aspect, the positioning device of the present disclosure preferably includes the following configuration. If the new reference calibration value is set in the second calibration control, the control unit outputs, to the target object moving unit, a calibrated position control signal obtained by calibrating the position control signal using a subtraction-side provisional calibration value or an addition-side provisional calibration value that was set as the new reference calibration value, and calculates a new addition-side provisional calibration value and subtraction-side provisional calibration value on the basis of the difference between the target position and the subtraction-side calibration measurement position or the addition-side calibration measurement position when the target object moving unit moves the target object toward the target position, on the basis of the calibrated position control signal.

In the configuration described above, the control unit sets a prescribed value to be added to or subtracted from the reference calibration value on the basis of the difference between the target position and the addition-side calibration measurement position, or the difference between the target position and the subtraction-side calibration measurement position. For example, the control unit increases or decreases the prescribed value in proportion to the difference between the target position and the addition-side calibration measurement position, or the difference between the target position and the subtraction-side calibration measurement position. That is, if it is considered from the relationship between the target position and the calibration measurement position that the reference calibration value is relatively far from the true calibration value, the difference between the reference calibration value and the addition-side provisional calibration value and the difference between the reference calibration value and the subtraction-side provisional calibration value are increased. Therefore, the greater the error between the target position and the addition-side calibration measurement position or the subtraction-side calibration measurement position, the more that the addition-side calibration measurement position or the subtraction-side calibration measurement position can be moved toward the target position. In addition, if the reference calibration value is relatively close to the true calibration value, the difference between the reference calibration value and the addition-side provisional calibration value and the difference between the reference calibration value and the subtraction-side provisional calibration value are decreased. Therefore, the smaller the error between the target position and the addition-side calibration measurement position or the subtraction-side calibration measurement position, the more precisely that the addition-side calibration measurement position or the subtraction-side calibration measurement position can be moved toward the target position. It is thereby possible to suppress the effect of calibration errors on the positioning accuracy, without using an electric actuator or a target object position measuring unit having higher accuracy.

According to another aspect, the positioning device of the present disclosure preferably includes the following configuration. The target object moving unit has at least one of an X-axis electric actuator that moves the target object in an X-axis direction, a Y-axis electric actuator that moves the target object in a Y-axis direction perpendicular to the X-axis direction, a Z-axis electric actuator that moves the target object in a Z-axis direction that is perpendicular to the X-axis direction and the Y-axis direction, and an electric actuator that rotates the target object around any one of the X-axis direction, the Y-axis direction, and the Z-axis direction.

In the configuration described above, the positioning device is able to bring, closer to the respective true calibration value, the reference calibration value for the movement in at least the X-axis direction, Y-axis direction, Z-axis direction, or around the axis that the target object moving unit can carry out. It is thereby possible to suppress the effect of calibration errors on the positioning accuracy, without using an electric actuator or a target object position measuring unit having higher accuracy.

The calibration method according to the embodiment of the present disclosure is a method of calibrating a target object moving unit that has at least one electric actuator and that can move a target object using the electric actuator. The calibration method comprises a first calibration step for calculating a reference calibration value of the position control signal on the basis of the target position and the measured position. In addition, the calibration method comprises an addition-side calibration measurement step for outputting, to the target object moving unit, a calibrated position control signal obtained by calibrating the position control signal using an addition-side provisional calibration value obtained by adding a prescribed value to the reference calibration value, and measuring an addition-side calibration measurement position of the target object moved by the target object moving unit on the basis of the calibrated position control signal. In addition, the calibration method comprises a subtraction-side calibration measurement step for outputting, to the target object moving unit, a calibrated position control signal obtained by calibrating the position control signal using a subtraction-side provisional calibration value obtained by subtracting a prescribed value from the reference calibration value, and measuring a subtraction-side calibration measurement position of the target object moved by the target object moving unit on the basis of the calibrated position control signal. In addition, the calibration method comprises a second calibration step for setting, as a new reference calibration value, a provisional calibration value used for calculation of the calibrated position control signal that moved the target object to the calibration measurement position that has a smaller difference from the target position, from among the addition-side calibration measurement position and the subtraction-side calibration measurement position.

In the configuration described above, on the basis of an addition-side calibration measurement position of a target object acquired in an addition-side calibration measurement step, a subtraction-side calibration measurement position of the target object acquired in a subtraction-side calibration measurement step, and a target position of the target object, the relationship between the reference calibration value and a true calibration value that matches the moved position of the target object to the target position in the second calibration step becomes clear. Therefore, calibration can be carried out using a provisional calibration value that brings the measured position closer to the target position than when using a calibrated position control signal calculated on the basis of the reference calibration value. It is thereby possible to suppress the effect of calibration errors on the positioning accuracy, without using an electric actuator or a target object position measuring unit having higher accuracy.

The technical language used in the present Specification is used only for the purpose of defining specific embodiments and is not intended to limit the invention with the technical language.

In the present Specification, the use of terms “including,” “comprising,” “having,” and variations thereof specifies the presence of the stated features, steps, operations, elements, components, and/or equivalents thereof, and may include one or more of the steps, operations, elements, components, and/or groups thereof.

In the present Specification, the terms “attached,” “connected,” “coupled,” and/or equivalents thereof are used in the broad senses thereof, and encompass both “direct and indirect” attachment, connection, and coupling. Further, “connected” and “coupled” are not limited to a physical or mechanical connection or coupling, and may encompass direct or indirect, electrical connection or coupling.

Unless otherwise defined, all terms (including technical terms and scientific terms) used in the present Specification have the same meanings as meanings commonly understood by a person skilled in the art of the technical field to which the invention belongs.

### (Target Object)

In the present Specification, a target object refers to a member moved by a target object moving unit. The target object includes, for example, substrates, elements, components, calibration and verification substrates, and the like. The target object is a member of a size that can be moved by the target object moving unit.

### (Electric Actuator)

In the present Specification, the electric actuator is a device that converts electrical energy to mechanical energy. The electric actuator comprises an electric motor, a linear motor, or the like, comprising a stator having a coil that generates a magnetic field using electricity, and a movable element that is moved relative to the stator by the magnetic field of the stator.

### (Target Object Position Measuring Unit)

In the present Specification, the target object position measuring unit refers to a device that outputs position information of the target object to be measured. The target object position measuring unit comprises, for example, a scale mounted on the target object moving unit, a camera that detects scale marks of the scale, and a processing device that calculates the position of the target object from an image captured by the camera. Alternatively, the target object position measuring unit is, for example, a detector mounted on the target object moving unit, and a scale whose scale marks are detected by the detector, the scale being provided on a stationary base. Alternatively, the target object position measuring unit is, for example, a position detection mark provided to the target object moving unit, a camera that detects the mark, and a processing device that calculates the position of the target object from an image captured by the camera. The target object position measuring unit includes, for example, an optical or magnetic linear scale, 2D scale, or the like. In addition, the target object position measuring unit includes a verification substrate, a verification chip, and the like, mounted on the target object moving unit.

### (Calibration)

In the present Specification, calibration refers to a series of operations that establishes the relationship between a value indicated by an instrument or measurement system, or the a value represented by a volumetric measuring device or reference material, and a value realized by a standard. In the calibration of the position detection device of the present embodiment, the relationship between a target position of the target object moving unit and a measured position of the target object position measuring unit is detected.

### (Calibration Value)

In the present Specification, a calibration value refers to a control coefficient for matching a moved position with a target position, the moved position being the position at which a target object is actually located when moved toward the target position. The calibration value is applied to a position control signal that is input with respect to target object movement for moving the target object.

### (Provisional Calibration Value)

In the present Specification, a provisional calibration value refers to a provisional calibration value obtained by intentionally increasing or decreasing the calibration value. In the present embodiment, an addition-side provisional calibration value is a provisional calibration value obtained by adding a prescribed value to the calibration value. In the present embodiment, a subtraction-side provisional calibration value is a provisional calibration value obtained by subtracting a prescribed value from the calibration value.

According to one embodiment of the present disclosure, in a positioning device comprising a target object moving unit that has at least one electric actuator and that can move a target object using the electric actuator, a target object position measuring unit that measures the moved position of the target object, and a control unit that outputs, to the target object moving unit, a position control signal for moving the target object to a target position and acquires a measured position of the target object measured by the target object position measuring unit, it is possible to suppress the effect of calibration errors on the positioning accuracy, without using an electric actuator or a target object position measuring unit having higher accuracy.

### BRIEF DESCRIPTION OF THE DRAWINGS

FIG. 1 is a plan view as viewed in a Z-axis direction and a side view as viewed in an X-axis direction of a positioning device according to an embodiment of the present disclosure.

FIG. 2 is a side view as viewed in a Y-axis direction of the positioning device according to the embodiment of the present disclosure.

FIG. 3 is a block diagram showing transmission of a control signal and position information when acquiring measured coordinates in a first calibration control of the positioning device according to the embodiment of the present disclosure.

FIG. 4 is a block diagram showing transmission of a control signal and position information when calculating a reference calibration value in the first calibration control of the positioning device according to the embodiment of the present disclosure.

FIG. 5 is a block diagram showing transmission of a control signal and position information when calculating a reference calibration value in a second calibration control of the positioning device according to the embodiment of the present disclosure.

FIG. 6 is a flowchart showing each step of the first calibration control and the second calibration control of the positioning device according to the embodiment of the present disclosure.

FIG. 7 is a schematic diagram showing an error between a target position and a measured position after positioning in the positioning device according to the embodiment of the present disclosure.

FIG. 8 is a schematic diagram showing the flow of updating a reference calibration value in the positioning device according to the embodiment of the present disclosure.

FIG. 9 is a flowchart of a first calibration control in the positioning device according to the embodiment of the present disclosure.

FIG. 10 is a flowchart of a second calibration control in the positioning device according to a first embodiment of the present disclosure.

FIG. 11 is a flowchart of the second calibration control in the positioning device according to a second embodiment of the present disclosure.

FIG. 12 is a flowchart of the second calibration control in the positioning device according to a third embodiment of the present disclosure.

### DETAILED DESCRIPTION OF EMBODIMENTS

A positioning device according to the present disclosure will be described below with reference to the drawings. In each figure, the same parts are given the same reference symbols, and explanations of the same parts will not be repeated. The dimensions of the component members in the drawings do not faithfully represent the actual dimensions of the component members or the dimensional ratios of each component member. In the following description of the embodiments of the present disclosure, the X-axis direction and the Y-axis direction are directions on a horizontal plane. The Y-axis direction is a direction perpendicular to the X-axis direction. The Z-axis direction is a direction perpendicular to the X-axis and Y-axis directions. However, the definition of these directions is not intended to limit the orientation of the positioning device during use in each of the embodiments.

In addition, in the following description, expressions such as “fix,” “connect,” “couple,” “attach,” etc., (hereinafter referred to as fixed, etc.) include not only cases in which members are directly fixed, etc., to each other, but also cases in which members are fixed, etc., via other members. That is, in the following description, expressions such as fixed, etc., include meanings of members being directly and indirectly fixed, etc., to each other.

### First Embodiment

### (Configuration of Positioning Device 1)

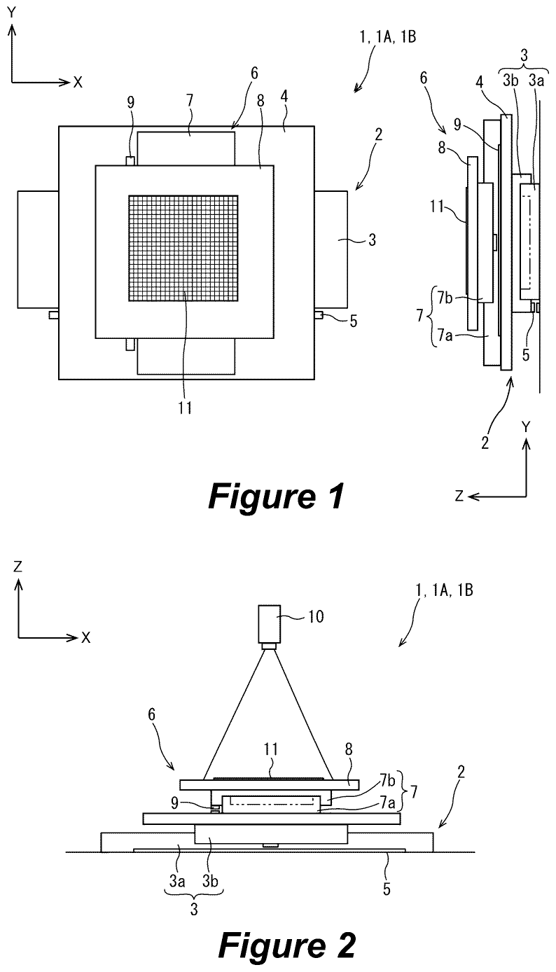

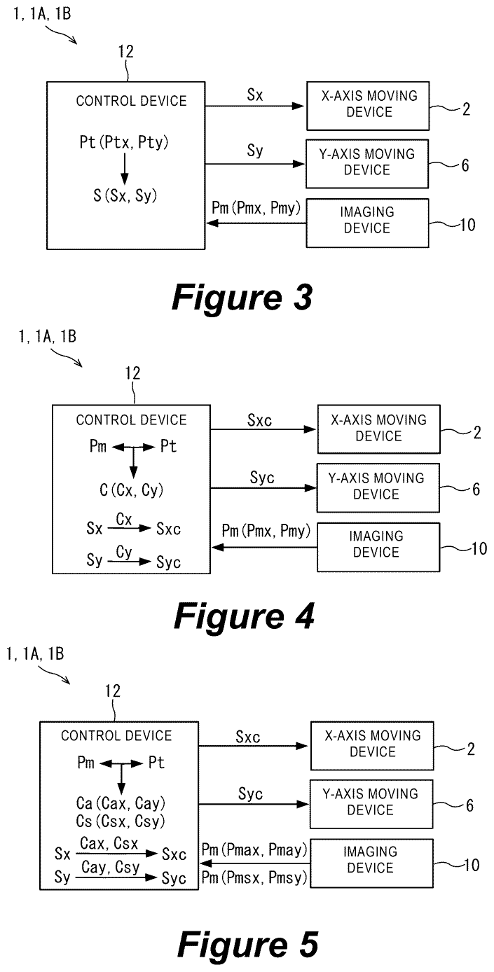

A positioning device 1, which is the first embodiment according to the present disclosure, will be described with reference to FIGS. 1 to 5. FIG. 1 is a plan view as viewed in a Z-axis direction and a side view as viewed in an X-axis direction of positioning devices 1, 1A, 1B according to an embodiment of the present disclosure. FIG. 2 is a side view as viewed in a Y-axis direction of the positioning devices 1, 1A, 1B. FIG. 3 is a block diagram showing transmission of a control signal and position information when acquiring a measured position Pm in a first calibration control S1 of the positioning devices 1, 1A, 1B. FIG. 4 is a block diagram showing transmission of a control signal and position information when calculating a reference calibration value C in the first calibration control S1 of the positioning devices 1, 1A, 1B. FIG. 5 is a block diagram showing transmission of a control signal and position information when calculating a new reference calibration value C in a second calibration control S2 of the positioning devices 1, 1A, 1B. In the following embodiments, the environmental temperature, which is the surrounding temperature when operating the positioning device, is preferably constant. If the environmental temperature is constant, the positioning device can reduce errors caused by temperature change, and carry out calibration with higher accuracy.

As shown in FIGS. 1 and 2, the positioning device 1 positions a target object. The positioning device 1 is provided in a manufacturing apparatus, such as a semiconductor manufacturing apparatus (not shown). The positioning device 1 comprises an X-axis moving device 2 constituting a target object moving unit, a Y-axis moving device 6 constituting the target object moving unit, an imaging device 10 (refer to FIG. 2) constituting a target object position measuring unit, a measurement substrate 11 constituting the target object position measuring unit, and a control device 12 (refer to FIG. 3) constituting a control unit.

The X-axis moving device 2 is a device that guides a target object to be positioned to a given position in the X-axis direction. For example, the X-axis moving device 2 is provided on a base of a manufacturing apparatus (not shown). The X-axis moving device 2 comprises an X-axis linear motor 3, which is an X-axis electric actuator, an X-axis table 4, and an X-axis scale 5.

The X-axis linear motor 3 is an actuator that generates driving force for moving the X-axis table 4. The X-axis linear motor 3 includes an X-axis rail 3a, an X-axis block 3b, and an X-axis thrust generating device, an amplifier, etc., which are not shown. The X-axis rail 3a is fixed to the base. The X-axis block 3b is supported by the X-axis rail 3a so as to be movable along the X-axis rail 3a.

The X-axis thrust generating device generates thrust using magnetic force. The X-axis thrust generating device is composed of a stator and a movable element. The stator is fixed to the X-axis rail 3a. The movable element is fixed to the X-axis block 3b. The X-axis thrust generating device generates thrust such that the X-axis block 3b moves, with respect to the base, in the direction in which the X-axis rail 3a extends.

The X-axis table 4 is a table that is moved in the X-axis direction by the X-axis linear motor 3. The X-axis table 4 is a flat plate-shaped member having sufficient rigidity. The X-axis table 4 is fixed to the X-axis block 3b. The Y-axis moving device 6 is mounted on the X-axis table 4.

The X-axis scale 5 detects the position of the X-axis block 3b. That is, the X-axis scale 5 detects the X-axis block 3b with respect to the base. The X-axis scale 5 is, for example, an optical linear scale.

The X-axis moving device 2 configured in the manner described above moves the X-axis table 4 fixed to the X-axis block 3b to a given position in the direction in which the X-axis rail 3a of the X-axis linear motor 3 extends, on the basis of the position of the X-axis block 3b of the X-axis linear motor 3 detected by the X-axis scale 5 of the X-axis linear motor 3. The X-axis moving device 2 moves the X-axis table 4 on the basis of an X-axis position control signal Sx included in a position control signal S input from the control device 12.

The Y-axis moving device 6 is a device that guides the target object to be positioned to a given position in the Y-axis direction. The Y-axis moving device 6 is provided on the X-axis table 4 of the X-axis moving device 2. The Y-axis moving device 6 comprises a Y-axis linear motor 7, which is a Y-axis electric actuator, a Y-axis table 8, and a Y-axis scale 9.

The Y-axis linear motor 7 is an actuator that generates driving force for moving the Y-axis table 8. The Y-axis linear motor 7 includes a Y-axis rail 7a, a Y-axis block 7b, and a Y-axis thrust generating device, an amplifier, etc., which are not shown. The Y-axis rail 7a is fixed to the X-axis table 4. The Y-axis block 7b is supported by the Y-axis rail 7a so as to be movable along the Y-axis rail 7a.

The Y-axis thrust generating device generates thrust using magnetic force. The Y-axis thrust generating device is composed of a stator and a movable element. The stator is fixed to the Y-axis rail 7a. The movable element is fixed to the Y-axis block 7b. The Y-axis thrust generating device generates thrust such that the Y-axis block 7b moves, with respect to the X-axis table 4, in the direction in which the Y-axis rail 7a extends.

The Y-axis table 8 is a table that is moved in the Y-axis direction by the Y-axis linear motor 7. The Y-axis table 8 is a flat plate-shaped member having sufficient rigidity. The Y-axis table 8 is fixed to the Y-axis block 7b of the Y-axis linear motor 7. A target object to be positioned or the measurement substrate 11 is mounted on the Y-axis table 8.

The Y-axis scale 9 detects the position of the movable element with respect to the stator of the Y-axis thrust generating device. That is, the Y-axis scale 9 detects the position of the Y-axis block 7b with respect to the X-axis table 4. The Y-axis scale 9 is, for example, an optical linear scale.

The Y-axis moving device 6 configured in the manner described above moves the Y-axis table 8 fixed to the Y-axis block 7b to a given position in the direction in which the Y-axis rail 7a of the Y-axis linear motor 7 extends, on the basis of the position of the Y-axis block 7b of the Y-axis linear motor 7 detected by the Y-axis scale 9 of the Y-axis linear motor 7. The Y-axis moving device 6 moves the Y-axis table 8 on the basis of a Y-axis position control signal Sy included in the position control signal S input from the control device 12.

The Y-axis table 8 of the Y-axis moving device 6 is moved to a given position in the Y-axis direction by the Y-axis linear motor 7 of the Y-axis moving device 6. In addition, the Y-axis moving device 6 is moved to a given position in the X-axis direction by the X-axis linear motor 3 of the X-axis moving device 2. Thus, the Y-axis table 8 is moved to a given position on an XY plane by the X-axis linear motor 3 and the Y-axis linear motor 7.

The imaging device 10 measures the position of the Y-axis table 8. For example, the imaging device 10 is composed of an undiagrammed position measuring device, etc., and a CCD camera that can capture images of the measurement substrate 11 or a target object to be positioned on the Y-axis table 8. The imaging device 10 is supported by the base. The CCD camera of the imaging device 10 can capture images of the measurement substrate 11 or a target object to be positioned that has been moved to a given position on the XY plane within the movable range of the X-axis linear motor 3 and the Y-axis linear motor 7. The position measuring device of the imaging device 10 calculates, from an image captured by the CCD camera, the X-axis coordinate and the Y-axis coordinate of a given point on the measurement substrate 11 or on the target object to be positioned, relative to the CCD camera. That is, the imaging device 10 functions as a target object position measuring unit that measures a measured X-axis coordinate Pmx and a measured Y-axis coordinate Pmy after movement of the Y-axis table 8 or the target object to be positioned, using the position of the CCD camera as reference.

The measurement substrate 11 is a substrate for verification having scale marks indicating positions on the substrate. The measurement substrate 11 is composed of glass, or the like, having a relatively small coefficient of thermal expansion. The measurement substrate 11 can be mounted on the Y-axis table 8. The measurement substrate 11 has scale marks arranged at prescribed intervals in the X direction from a reference point, and scale marks arranged at prescribed intervals in the Y direction from the reference point. That is, the measurement substrate 11 indicates the X coordinate and the Y coordinate of any given position from the reference point on the substrate. If mounted on the Y-axis table 8, the measurement substrate 11 indicates the measured X-axis coordinate Pmx and the measured Y-axis coordinate Pmy of the Y-axis table 8. The measurement substrate 11 can be used as a measurement substrate for verification and calibration of the positioning device 1.

As shown in FIGS. 3 to 5, the control device 12 serving as a control unit controls the X-axis moving device 2, the Y-axis moving device 6, and the imaging device 10. Substantively, the control device 12 includes a CPU, ROM, RAM, HDD, etc., which are connected via a bus. In addition, the control device 12 may be composed of a single-chip LSI, or the like. The control device 12 stores various programs and data for controlling the operations of the X-axis moving device 2, the Y-axis moving device 6, and the imaging device 10.

The control device 12 is configured to be capable of outputting, to the X-axis moving device 2 and the Y-axis moving device 6, the position control signal S for positioning, to a target position Pt, the Y-axis table 8 on which a target object to be positioned or the measurement substrate 11 is mounted. The target position Pt includes a target X-axis coordinate Ptx and a target Y-axis coordinate Pty. The position control signal S includes the X-axis position control signal Sx with respect to the target X-axis coordinate Ptx at the target position Pt, and the Y-axis position control signal Sy with respect to the target Y-axis coordinate Pty at the target position Pt.

The control device 12 is electrically connected to the X-axis linear motor 3 (refer to FIG. 1) of the X-axis moving device 2 and the Y-axis linear motor 7 (refer to FIG. 1) of the Y-axis moving device 6. The control device 12 transmits, to the X-axis linear motor 3, the X-axis position control signal Sx in the position control signal S. In addition, the control device 12 transmits, to the Y-axis linear motor 7, the Y-axis position control signal Sy in the position control signal S.

The control device 12 is electrically connected to the imaging device 10. The control device 12 outputs, to the imaging device 10, a control signal for calculating a measured position Pm of the measurement substrate 11 or the target object to be positioned on the Y-axis table 8. The measured position Pm includes the measured X-axis coordinate Pmx and the measured Y-axis coordinate Pmy. The control device 12 acquires the measured X-axis coordinate Pmx and the measured Y-axis coordinate Pmy at the measured position Pm of the Y-axis table 8 on which the measurement substrate 11 or the target object to be positioned is mounted, as calculated by the imaging device 10.

As shown in FIG. 4, the control device 12 can execute a first calibration control S1 that calculates a reference calibration value C, which is the calibration value of the position control signal S for bringing the measured position Pm closer to the target position Pt, on the basis of the target position Pt and the measured position Pm. The reference calibration value C includes an X-axis reference calibration value Cx for calibrating the X-axis position control signal Sx, and a Y-axis reference calibration value Cy for calibrating the Y-axis position control signal Sy.

As shown in FIG. 5, the control device 12 can execute a second calibration control S2 that calculates an addition-side provisional calibration value Ca and a subtraction-side provisional calibration value Cs, which are calibration values of the position control signal S for bringing the measured position Pm even closer to the target position Pt. The addition-side provisional calibration value Ca is a provisional calibration value obtained by adding a prescribed value to the reference calibration value C (refer to FIG. 5). The subtraction-side provisional calibration value Cs is a provisional calibration value obtained by subtracting a prescribed value from the reference calibration value C. The addition-side provisional calibration value Ca includes an X-axis addition-side provisional calibration value Cax for calibrating the X-axis position control signal Sx, and a Y-axis addition-side provisional calibration value Cay for calibrating the Y-axis position control signal Sy. The subtraction-side provisional calibration value Cs includes an X-axis subtraction-side provisional calibration value Csx for calibrating the X-axis position control signal Sx, and a Y-axis subtraction-side provisional calibration value Csy for calibrating the Y-axis position control signal Sy.

The positioning device 1 configured in this manner outputs, from the control device 12, the X-axis position control signal Sx to the X-axis moving device 2 and the Y-axis position control signal Sy to the Y-axis moving device 6, in order to position the target object to be positioned at the target X-axis coordinate Ptx and the target Y-axis coordinate Pty. The positioning device 1 moves the target object to be positioned toward the target X-axis coordinate Ptx, by means of movement by the X-axis moving device 2 based on the X-axis position control signal Sx and movement by the Y-axis moving device 6 based on the Y-axis position control signal Sy. In addition, the positioning device 1 calculates the reference calibration value C in the first calibration control S1, and updates the reference calibration value C in the second calibration control S2 using the addition-side provisional calibration value Ca and the subtraction-side provisional calibration value Cs.

### (Calibration Method in the Positioning Device 1)

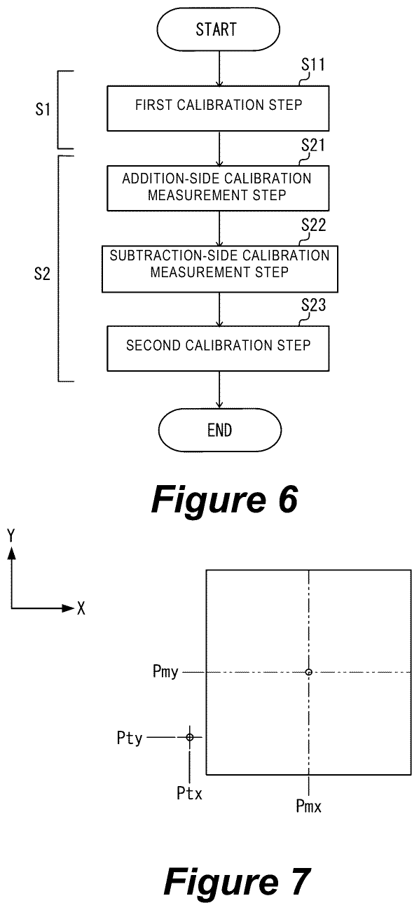

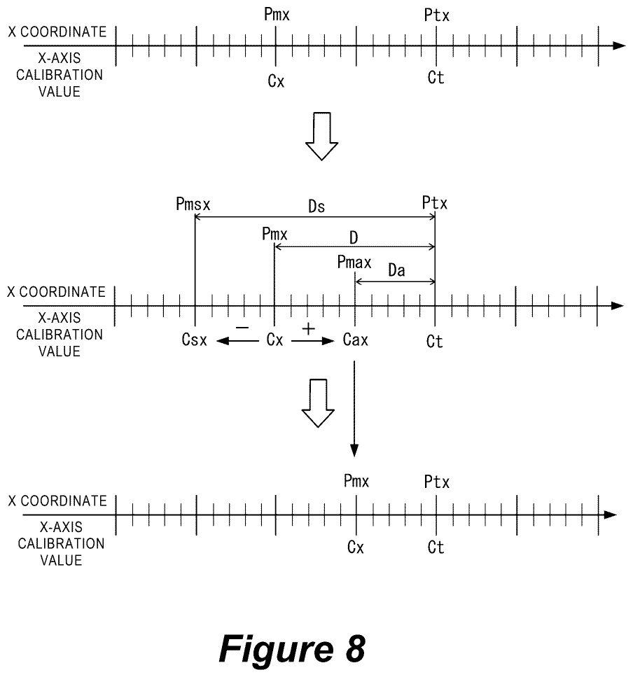

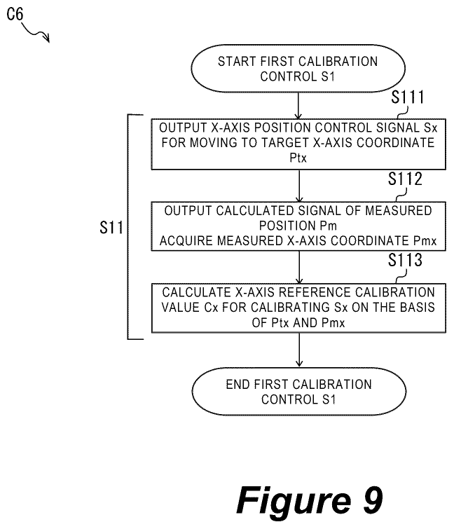

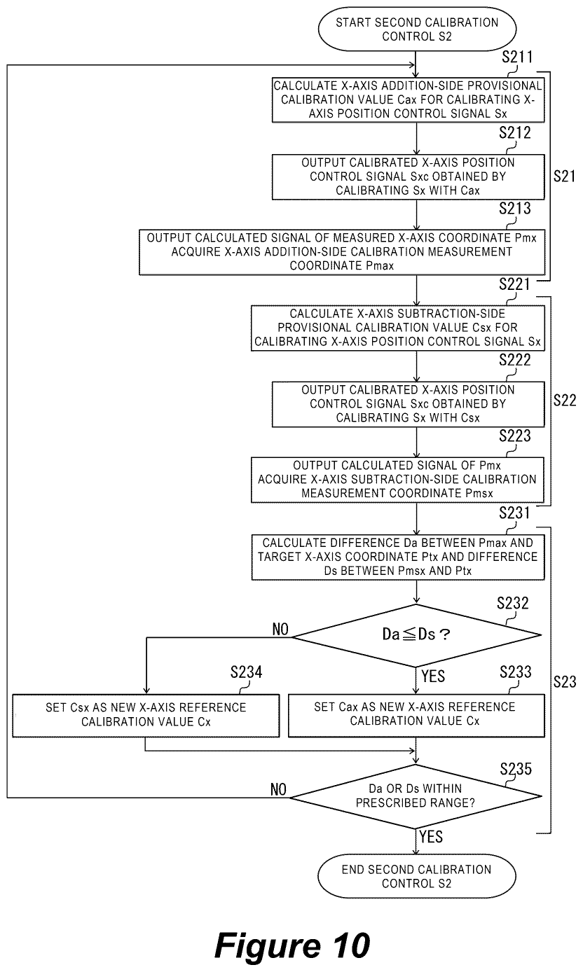

The first calibration control S1 and the second calibration control S2, which are calibration methods for the target object moving unit composed of the X-axis moving device 2 and the Y-axis moving device 6 that can move the measurement substrate 11 mounted on the Y-axis table 8, will be described next with reference to FIGS. 3 to 10. FIG. 6 is a flowchart showing each step of the first calibration control S1 and the second calibration control S2 of the positioning devices 1, 1A, 1B. FIG. 7 is a schematic diagram showing an error between the target position Pt and the measured position Pm after positioning in the positioning devices 1, 1A, 1B. FIG. 8 is a schematic diagram showing the flow of updating the reference calibration value C in the positioning device 1. FIG. 9 is a flowchart of the first calibration control S1 in the positioning devices 1, 1A, 1B. FIG. 10 is a flowchart of the second calibration control S2 in the positioning device 1.

In the following description of the embodiments, the first calibration control S1 and the second calibration control S2 for bringing the measured Y-axis coordinate Pmy closer to the target Y-axis coordinate Pty in the Y-axis moving device 6, and the first calibration control S1 and the second calibration control S2 for bringing the measured position Pm closer to the target position Pt in the X-axis moving device 2 and the Y-axis moving device 6, are similar controls and thus descriptions thereof will be omitted. In addition, the measurement substrate 11 is mounted on the Y-axis table 8 of the positioning device 1.

As shown in FIG. 6, the first calibration control S1 has a first calibration step S11. The second calibration control S2 has an addition-side calibration measurement step S21, a subtraction-side calibration measurement step S22, and a second calibration step S23.

As shown in FIGS. 3, 4, 6, and 7, the first calibration step S11 of the first calibration control S1 is a step for calculating the X-axis reference calibration value Cx of the X-axis position control signal Sx on the basis of the error between the target position Pt and the measured position Pm (refer to FIG. 7). In the present embodiment, the control device 12 of the positioning device 1 calculates the X-axis reference calibration value Cx for calibrating the X-axis position control signal Sx output to the X-axis moving device 2, on the basis of the target X-axis coordinate Ptx of the X-axis table 4 (refer to FIG. 1) and the Y-axis table 8 (refer to FIG. 1) (hereinafter simply referred to as “Y-axis table 8”) moved by the X-axis moving device 2, and the measured X-axis coordinate Pmx of the Y-axis table 8 calculated from an image of the scale marks of the measurement substrate 11 (refer to FIG. 1) captured by the imaging device 10. The X-axis reference calibration value Cx is a calibration value for calibrating the X-axis position control signal Sx such that the measured X-axis coordinate Pmx of the Y-axis table 8 moved by the X-axis moving device 2 comes closer to the target X-axis coordinate Ptx.

In the present embodiment, the control device 12 of the positioning device 1 calculates the measured X-axis coordinate Pmx included in the measured position Pm on the basis of an image captured by the imaging device 10. Coordinates on the image are determined by the number of pixels of a CCD image sensor, etc., provided in the imaging device 10. Thus, the measured X-axis coordinate Pmx is calculated by converting the coordinates on the image to coordinates on the measurement substrate 11.

On the other hand, the image is created on the basis of the CCD image sensor that receives light that has passed through a lens of the imaging device 10, and thus contains unit-to-unit variations of the CCD image sensor, the lens of the imaging device 10, the position of the lens, etc. Furthermore, the measured X-axis coordinate Pmx includes, in addition to the unit-to-unit variations of the imaging device 10, structural errors and control errors of the X-axis moving device 2 and the Y-axis moving device 6. In order to calibrate for errors caused by the X-axis moving device 2, the Y-axis moving device 6, and the imaging device 10, the control device 12 calculates the X-axis reference calibration value Cx, which is the resolution per one pixel of the image (the amount of movement in the X direction per one pixel), on the basis of the target X-axis coordinate Ptx and the measured X-axis coordinate Pmx.

As shown in FIGS. 5 and 6, the addition-side calibration measurement step S21 of the second calibration control S2 includes a step for calculating an X-axis addition-side provisional calibration value Cax obtained by adding a prescribed value to the X-axis reference calibration value Cx, a step for moving the Y-axis table 8 toward the target X-axis coordinate Ptx on the basis of a calibrated X-axis position control signal Sxc calibrated using the X-axis addition-side provisional calibration value Cax, and a step for measuring an X-axis addition-side calibration measurement coordinate Pmax at the moved position of the Y-axis table 8 (refer to FIG. 1) that has been moved.

In the present embodiment, the control device 12 outputs, to the X-axis moving device 2, the calibrated X-axis position control signal Sxc obtained by calibrating the X-axis position control signal Sx using the X-axis addition-side provisional calibration value Cax. The calibrated X-axis position control signal Sxc is included in a calibrated position control signal Sc. The X-axis moving device 2 moves the Y-axis table 8 toward the target X-axis coordinate Ptx on the basis of the calibrated X-axis position control signal Sxc. The control device 12 measures, using the imaging device 10, the X-axis addition-side calibration measurement coordinate Pmax at the moved position of the Y-axis table 8 that has been moved by the X-axis moving device 2. The calibrated position control signal Sc includes, with respect to the Y-axis moving device 6, a calibrated Y-axis position control signal Syc obtained by calibrating the Y-axis position control signal Sy using the Y-axis addition-side provisional calibration value Cay or the Y-axis subtraction-side provisional calibration value Csy.

The subtraction-side calibration measurement step S22 of the second calibration control S2 includes a step for calculating the calibrated X-axis position control signal Sxc obtained by calibrating the X-axis position control signal Sx using the X-axis subtraction-side provisional calibration value Csx obtained by subtracting a prescribed value from the X-axis reference calibration value Cx, a step for moving the Y-axis table 8 toward the target X-axis coordinate Ptx on the basis of the calibrated X-axis position control signal Sxc calibrated by the X-axis subtraction-side provisional calibration value Csx, and a step for measuring an X-axis subtraction-side calibration measurement coordinate Pmsx at the moved position of the Y-axis table 8 that has been moved.

In the present embodiment, the control device 12 outputs, to the X-axis moving device 2, the calibrated X-axis position control signal Sxc obtained by calibrating the X-axis position control signal Sx using the X-axis subtraction-side provisional calibration value Csx. The calibrated X-axis position control signal Sxc is included in the calibrated position control signal Sc. The X-axis moving device 2 moves the Y-axis table 8 toward the target X-axis coordinate Ptx on the basis of the calibrated X-axis position control signal Sxc. The control device 12 measures, using the imaging device 10, the X-axis subtraction-side calibration measurement coordinate Pmsx at the moved position of the Y-axis table 8 that has been moved by the X-axis moving device 2.

The second calibration step S23 of the second calibration control S2 includes a step for selecting, from among the X-axis addition-side calibration measurement coordinate Pmax and the X-axis subtraction-side calibration measurement coordinate Pmsx, the calibration measurement coordinate whose difference from the target X-axis coordinate Ptx is smaller and that is smaller than the difference between the measured X-axis coordinate Pmx and the target X-axis coordinate Ptx, and a step for setting, as a new X-axis reference calibration value Cx, the provisional calibration value used for calculating the calibrated X-axis position control signal Sxc that moved the Y-axis table 8 to the selected calibration measurement coordinate.

As shown in FIG. 8, in the present embodiment, the control device 12 selects the X-axis addition-side provisional calibration value Cax from among the X-axis addition-side provisional calibration value Cax and the X-axis subtraction-side provisional calibration value Csx when, for example, the difference Da between the target X-axis coordinate Ptx and the X-axis addition-side calibration measurement coordinate Pmax is smaller than the difference D between the measured X-axis coordinate Pmx and the target X-axis coordinate Ptx, and is smaller than the difference Ds between the target X-axis coordinate Ptx and the X-axis subtraction-side calibration measurement coordinate Pmsx. The control device 12 sets the selected X-axis addition-side provisional calibration value Cax as the new X-axis reference calibration value Cx.

The first calibration control S1 and the second calibration control S2 according to the first embodiment of the positioning device 1 of the present disclosure will be specifically described, with reference to FIGS. 9 and 10. In the present embodiment, the difference Ds between the target X-axis coordinate Ptx and the X-axis subtraction-side calibration measurement coordinate Pmsx and the difference Da between the target X-axis coordinate Ptx and the X-axis addition-side calibration measurement coordinate Pmax are smaller than the difference D (refer to FIG. 8) between the measured X-axis coordinate Pmx and the target X-axis coordinate Ptx.

As shown in FIG. 9, in step S111 of the first calibration step S11 included in the first calibration control S1, the control device 12 outputs, to the X-axis moving device 2, the X-axis position control signal Sx that moves the Y-axis table 8 mounted on the X-axis table 4 to the target X-axis coordinate Ptx. The X-axis moving device 2 moves the X-axis table 4 toward the target X-axis coordinate Ptx on the basis of the output of the X-axis scale 5. The control device 12 advances the process to step S112.

In step S112, the control device 12 outputs, to the imaging device 10, a control signal for calculating the measured position Pm, which is the moved position of the Y-axis table 8 that has been moved. The imaging device 10 captures an image of the measurement substrate 11 of the Y-axis table 8 in accordance with the control signal. Furthermore, the control device 12 calculates the measured position Pm, which is the moved position of the Y-axis table 8, from the captured image of scale marks of the measurement substrate 11. The control device 12 acquires the measured X-axis coordinate Pmx from the imaging device 10. The control device 12 advances the process to step S113.

In step S113, the control device 12 calculates the X-axis reference calibration value Cx for calibrating the X-axis position control signal Sx on the basis of the target X-axis coordinate Ptx and the measured X-axis coordinate Pmx acquired from the imaging device 10. The control device 12 ends the first calibration control S1 including the first calibration step S11, and advances the process to the addition-side calibration measurement step S21 of the second calibration control S2 (refer to FIG. 10).

As shown in FIG. 10, in step S211 of the addition-side calibration measurement step S21 in the second calibration control S2, the control device 12 calculates the X-axis addition-side provisional calibration value Cax, obtained by adding a prescribed value to the X-axis reference calibration value Cx calculated in the first calibration control S1 (refer to FIG. 9). The control device 12 advances the process to step S212.

In step S212, the control device 12 outputs, to the X-axis moving device 2, the calibrated X-axis position control signal Sxc obtained by calibrating the X-axis position control signal Sx using the X-axis addition-side provisional calibration value Cax. The X-axis moving device 2 moves the Y-axis table 8 toward the target X-axis coordinate Ptx. The control device 12 advances the process to step S213.

In step S213, the control device 12 outputs, to the imaging device 10, a control signal for calculating the measured X-axis coordinate Pmx, which is the moved position of the Y-axis table 8 that has been moved. The imaging device 10 captures an image of the measurement substrate 11 in accordance with the control signal. Furthermore, the imaging device 10 calculates, from the captured image of scale marks of the measurement substrate 11, the X-axis addition-side calibration measurement coordinate Pmax included in an addition-side calibration measurement position (calibration measurement position) Pma, which is the moved position of the Y-axis table 8. The control device 12 acquires the X-axis addition-side calibration measurement coordinate Pmax from the imaging device 10. The control device 12 advances the process to step S221 of the subtraction-side calibration measurement step S22.

In step S221 of the subtraction-side calibration measurement step S22, the control device 12 calculates the X-axis subtraction-side provisional calibration value Csx obtained by subtracting a prescribed value from the X-axis reference calibration value Cx calculated in the first calibration control S1 (refer to FIG. 9). The control device 12 advances the process to step S222.

In step S222, the control device 12 outputs, to the X-axis moving device 2, the calibrated X-axis position control signal Sxc obtained by calibrating the X-axis position control signal Sx using the X-axis subtraction-side provisional calibration value Csx. The X-axis moving device 2 moves the Y-axis table 8 toward the target X-axis coordinate Ptx. The control device 12 advances the process to step S223.

In step S223, the control device 12 outputs, to the imaging device 10, a control signal for calculating the measured X-axis coordinate Pmx of the Y-axis table 8 that has been moved. The imaging device 10 captures an image of the measurement substrate 11 in accordance with the control signal. Furthermore, the imaging device 10 calculates, from the captured image of scale marks of the measurement substrate 11, the X-axis subtraction-side calibration measurement coordinate Pmsx included in a subtraction-side calibration measurement position (calibration measurement position) Pms, which is the moved position of the Y-axis table 8. The imaging device 10 outputs the calculated X-axis subtraction-side calibration measurement coordinate Pmsx to the control device 12. The control device 12 advances the process to step S231 of the second calibration step S23.

In step S231 of the second calibration step S23, the control device 12 calculates the difference Da between the X-axis addition-side calibration measurement coordinate Pmax and the target X-axis coordinate Ptx, and the difference Ds between the X-axis subtraction-side calibration measurement coordinate Pmsx and the target X-axis coordinate Ptx. The control device 12 advances the process to step S232.

In step S232, the control device 12 determines whether the difference Da is less than or equal to the difference Ds. As a result, if it is determined that the difference Da is less than or equal to the difference Ds, the control device 12 advances the process to step S233. On the other hand, if it is determined that the difference Ds less than the difference Da, the control device 12 advances the process to step S234.

In step S233, the control device 12 sets the X-axis addition-side provisional calibration value Cax as the new X-axis reference calibration value Cx. The control device 12 advances the process to step S235.

In step S234, the control device 12 sets the X-axis subtraction-side provisional calibration value Csx as the new X-axis reference calibration value Cx. The control device 12 advances the process to step S235.

In step S235, the control device 12 determines whether the difference Da or the difference Ds is within a prescribed range.

As a result, if it is determined that the difference Da or the difference Ds is within the prescribed range, the control device 12 ends the second calibration control S2.

On the other hand, if it is determined that the difference Da and the difference Ds are outside the prescribed range, the control device 12 advances the process to step S211. That is, the control device 12 executes the addition-side calibration measurement step S21, the subtraction-side calibration measurement step S22, and the second calibration step S23 again.

The positioning device 1 configured in this manner executes the first calibration control S1 for calculating the reference calibration value C and the second calibration control for calculating a new reference calibration value C. In the second calibration control S2, the control device 12 compares the addition-side calibration measurement position Pma based on the addition-side provisional calibration value Ca obtained by adding a prescribed value to the reference calibration value C with the subtraction-side calibration measurement position Pms based on the subtraction-side provisional calibration value Cs obtained by subtracting a prescribed value from the reference calibration value C, thereby clarifying the relationship between the reference calibration value C and a true calibration value Ct that matches the measured position Pm with the target position Pt. Thus, the control device 12 can reduce the calibration error by selecting, as the new reference calibration value C, the addition-side provisional calibration value Ca or the subtraction-side provisional calibration value Cs for calculating the calibrated position control signal Sc that brings the measured position Pm closer to the target position Pt than the reference calibration value C.

In addition, the control device 12 carries out the second calibration control S2 until the difference between the target position Pt and the addition-side calibration measurement position Pma based on the addition-side provisional calibration value Ca calculated in the second calibration control S2 and/or the difference between the target position Pt and the subtraction-side calibration measurement position Pms based on the subtraction-side provisional calibration value Cs falls within a prescribed range. Therefore, the positioning accuracy using the new reference calibration value C set in the second calibration control S2 is maintained at or above a prescribed accuracy. It is thereby possible to suppress the effect of calibration errors on the positioning accuracy, without using the X-axis moving device 2, the Y-axis moving device 6, and the imaging device 10 having higher accuracy.

In addition, the relationship between the reference calibration value C and the true calibration value Ct that matches the measured position Pm with the target position Pt in the second calibration step S23 becomes clear on the basis of the addition-side calibration measurement position Pma acquired in the addition-side calibration measurement step S21 and the subtraction-side calibration measurement position Pms acquired in the subtraction-side calibration measurement step S22. Therefore, the addition-side provisional calibration value Ca or the subtraction-side provisional calibration value Cs is able to calculate the calibrated position control signal Sc that brings the measured position Pm closer to the target position Pt than the calibrated position control signal Sc calculated based on the reference calibration value C. It is thereby possible to suppress the effect of calibration errors on the positioning accuracy, without using the X-axis moving device 2, the Y-axis moving device 6, and the imaging device 10 having higher accuracy.

### Second Embodiment

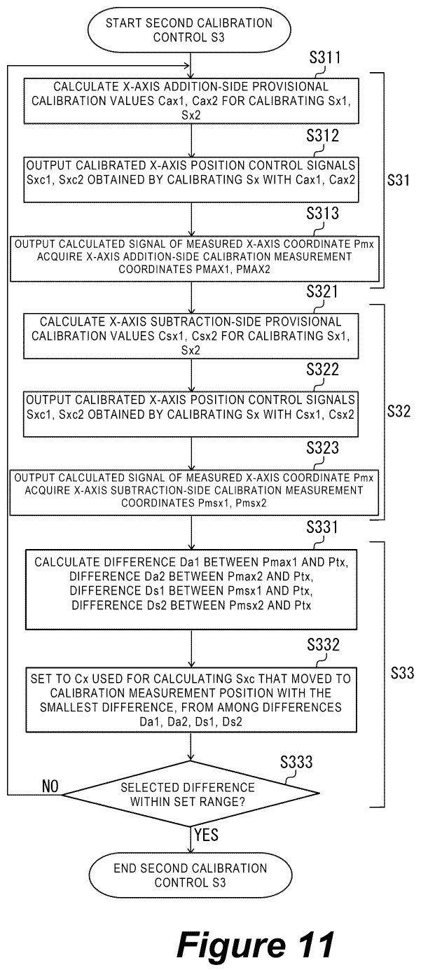

A positioning device 1A according to a second embodiment of the positioning device of the present disclosure will be described next, with reference to FIG. 11. FIG. 11 is a flowchart of a second calibration control S3 in the positioning device 1A according to the second embodiment of the present disclosure. In the following embodiments, the configurations that are the same as the first embodiment have been assigned the same reference symbols and the descriptions thereof will be omitted, and only parts that differ from the first embodiment will be described.

### (Calibration Method in the Positioning Device 1A)

The first calibration control S1 and the second calibration control S3, which are calibration methods for the X-axis moving device 2 (refer to FIG. 1) and the Y-axis moving device 6 (refer to FIG. 1) will be described. The calibration method according to the second embodiment is different from the calibration method of the first embodiment in the point of carrying out calibration using a plurality of different provisional calibration values that are set in advance. It is assumed that the X-axis reference calibration value Cx has been calculated in the first calibration control S1 (refer to FIG. 9).

As shown in FIG. 11, an addition-side calibration measurement step S31 of the second calibration control S3 includes a step for calculating a plurality of calibrated X-axis position control signals Sxc obtained by calibrating the X-axis position control signal Sx using a plurality of the X-axis addition-side provisional calibration values Cax, obtained by adding different prescribed values to the X-axis reference calibration value Cx, a step for the X-axis moving device 2 to respectively move the Y-axis table 8 to the target X-axis coordinates Ptx on the basis of the plurality of calculated calibrated X-axis position control signals Sxc, and a step for respectively measuring the X-axis addition-side calibration measurement coordinates Pmax at the moved positions of the Y-axis table 8 that has been moved (refer to steps S311 to S313).

In the present embodiment, the control device 12 outputs, to the X-axis moving device 2, a first calibrated X-axis position control signal Sxc1 obtained by calibrating the X-axis position control signal Sx using a first X-axis addition-side provisional calibration value Cax1 obtained by adding a first prescribed value to the X-axis reference calibration value Cx. Similarly, the control device 12 outputs, to the X-axis moving device 2, a second calibrated X-axis position control signal Sxc2 obtained by calibrating the X-axis position control signal Sx using a second X-axis addition-side provisional calibration value Cax2 that is different in value from the first X-axis addition-side provisional calibration value Cax1 (refer to steps S311 and S312).

The control device 12 measures, using the imaging device 10, the moved position of the Y-axis table 8 that has been moved toward the target X-axis coordinate Ptx by the X-axis moving device 2, on the basis of the first calibrated X-axis position control signal Sxc1. The control device 12 acquires a first X-axis addition-side calibration measurement coordinate Pmax1 from the imaging device 10. Similarly, the control device 12 measures, using the imaging device 10, the moved position of the Y-axis table 8 that has been moved toward the target X-axis coordinate Ptx by the X-axis moving device 2, on the basis of the second calibrated X-axis position control signal Sxc2. The control device 12 acquires a second X-axis addition-side calibration measurement coordinate Pmax2 from the imaging device 10 (refer to step S313).

A subtraction-side calibration measurement step S32 of the second calibration control S3 includes a step for calculating a plurality of calibrated X-axis position control signals Sxc obtained by calibrating the X-axis position control signal Sx using a plurality of the X-axis subtraction-side provisional calibration values Csx obtained by subtracting different prescribed values from the X-axis reference calibration value Cx, a step for the X-axis moving device 2 to respectively move the Y-axis table 8 to the target X-axis coordinates Ptx on the basis of the plurality of calculated calibrated X-axis position control signals Sxc, and a step for respectively measuring the X-axis subtraction-side calibration measurement coordinate Pmsx at the moved positions of the Y-axis table 8 that has been moved (refer to steps S321 to S323).

In the present embodiment, the control device 12 outputs, to the X-axis moving device 2, a first calibrated X-axis position control signal Sxc1 obtained by calibrating the X-axis position control signal Sx using a first X-axis subtraction-side provisional calibration value Csx1 obtained by subtracting a first prescribed value from the X-axis reference calibration value Cx. Similarly, the control device 12 outputs, to the X-axis moving device 2, a second calibrated X-axis position control signal Sxc2 obtained by calibrating the X-axis position control signal Sx using a second X-axis subtraction-side provisional calibration value Csx2 that is different in value from the first X-axis subtraction-side provisional calibration value Csx1 (refer to steps S321 and S322).

The control device 12 measures, using the imaging device 10, the moved position of the Y-axis table 8 that has been moved toward the target X-axis coordinate Ptx by the X-axis moving device 2, on the basis of the first calibrated X-axis position control signal Sxc1. The control device 12 acquires a first X-axis subtraction-side calibration measurement coordinate Pmsx1 from the imaging device 10. Similarly, the control device 12 measures, using the imaging device 10, the moved position of the Y-axis table 8 that has been moved toward the target X-axis coordinate Ptx by the X-axis moving device 2, on the basis of the second calibrated X-axis position control signal Sxc2. The control device 12 acquires a second X-axis subtraction-side calibration measurement coordinate Pmsx2 from the imaging device 10 (refer to step S323).

A second calibration step S33 of the second calibration control S3 includes a step for calculating a difference Da1 between the first X-axis addition-side calibration measurement coordinate Pmax1 and the target X-axis coordinate Ptx and a difference Da2 between the second X-axis addition-side calibration measurement coordinate Pmax2 and the target X-axis coordinate Ptx, as well as a difference Ds1 between the first X-axis subtraction-side calibration measurement coordinate Pmsx1 and the target X-axis coordinate Ptx and a difference Ds2 between the second X-axis subtraction-side calibration measurement coordinate Pmsx2 and the target X-axis coordinate Ptx, and a step for setting, as the new X-axis reference calibration value Cx, a provisional calibration value of the calibrated X-axis position control signal Sxc that has moved the Y-axis table 8 to the calibration measurement coordinate whose difference (Da1, Da2, Ds1, Ds2) is the smallest among the calibration measurement coordinates Pmax1, Pmax2, Pmsx1 and Pmsx2.

In the present embodiment, the control device 12 selects the first X-axis addition-side provisional calibration value Cax1 when, for example, the difference Da1 between the target X-axis coordinate Ptx and the first X-axis addition-side calibration measurement coordinate Pmax1 is the smallest. The control device 12 sets the selected first X-axis addition-side provisional calibration value Cax1 as the new X-axis reference calibration value Cx (refer to steps S331 to S333).

With this configuration, the control device 12 of the positioning device 1A calculates the difference between the target X-axis coordinate Ptx and the measured position Pm of the Y-axis table 8 that was moved on the basis of a plurality of calibrated position control signals Sc calibrated by a plurality of different X-axis subtraction-side provisional calibration values Csx and a plurality of different X-axis addition-side provisional calibration values Cax that are set in advance, and thus can set an appropriate calibration value as the reference calibration value even if there is a plurality of true calibration values Ct. It is thereby possible to suppress the effect of calibration errors on the positioning accuracy, without using the X-axis moving device 2, the Y-axis moving device 6, and the imaging device 10 having higher accuracy.

### Third Embodiment

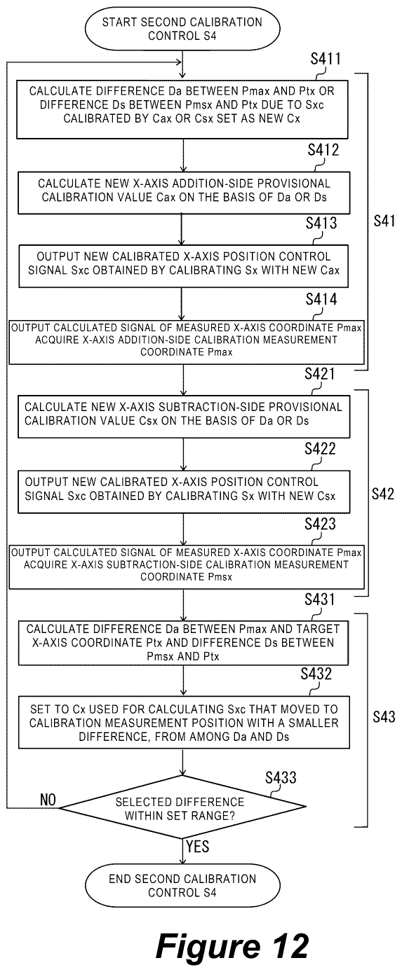

A positioning device 1B according to a third embodiment of the positioning device of the present disclosure will be described next, with reference to FIG. 12. FIG. 12 is a flowchart of a second calibration control in the positioning device 1B according to the third embodiment of the present disclosure.

### (Calibration Method in the Positioning Device 1B)

The first calibration control S1 and a second calibration control S4, which are calibration methods for the X-axis moving device 2 (refer to FIG. 1) and the Y-axis moving device 6 (refer to FIG. 1) will be described. The calibration method according to the third embodiment is different from the calibration method of the first embodiment in the point of calculating the provisional calibration value on the basis of the difference between the target position Pt and the measured position Pm. It is assumed that the X-axis reference calibration value Cx has been calculated in the first calibration control S1 (refer to FIG. 9). In addition, in the second calibration control S4, it is assumed that a new X-axis reference calibration value Cx has been calculated on the basis of the X-axis addition-side provisional calibration value Cax or the X-axis subtraction-side provisional calibration value Csx through the step described in the first embodiment.

As shown in FIG. 12, in the second calibration control S4, an addition-side calibration measurement step S41 after the new X-axis reference calibration value Cx has been set includes a step for the X-axis moving device 2 to move the Y-axis table 8 on the basis of the calibrated X-axis position control signal Sxc calibrated by the X-axis addition-side provisional calibration value Cax or the X-axis subtraction-side provisional calibration value Csx that has been set as the new X-axis reference calibration value Cx, a step for calculating the difference Ds between the X-axis subtraction-side calibration measurement coordinate Pmsx and the target X-axis coordinate Ptx or the difference Da between the X-axis addition-side calibration measurement coordinate Pmax and the target X-axis coordinate Ptx of the Y-axis table 8 that has been moved, and a step for calculating the new X-axis addition-side provisional calibration value Cax on the basis of the difference Da and the difference Ds (refer to steps S411 to S414).

That is, the addition-side calibration measurement step S41 calculates the new X-axis addition-side provisional calibration value Cax on the basis of the difference between the target X-axis coordinate Ptx and the measured X-axis coordinate Pmx of the Y-axis table 8 moved on the basis of the calibrated X-axis position control signal Sxc. The new addition-side provisional calibration value Cax is set to a value proportional to the difference between the X-axis addition-side calibration measurement coordinate Pmax and the target X-axis coordinate Ptx, for example.

In the present embodiment, in the addition-side calibration measurement step S41 in which the new X-axis reference calibration value Cx is set, the control device 12 calculates the new X-axis addition-side provisional calibration value Cax that is proportional to the difference Ds between the X-axis subtraction-side calibration measurement coordinate Pmsx and the target X-axis coordinate Ptx or the difference Da between the X-axis addition-side calibration measurement coordinate Pmax and the target X-axis coordinate Ptx of the Y-axis table 8 calculated when the new X-axis reference calibration value Cx was set. The control device 12 outputs, to the X-axis moving device 2, the new calibrated X-axis position control signal Sxc obtained by calibrating X-axis position control signal Sx using the new X-axis addition-side provisional calibration value Cax (refer to steps S411 to S413).

The control device 12 measures and acquires, using the imaging device 10, the X-axis addition-side calibration measurement coordinate Pmax of the Y-axis table 8 moved toward the target X-axis coordinate Ptx by the X-axis moving device 2, on the basis of the new calibrated X-axis position control signal Sxc (refer to step S414).

In the second calibration control S4, a subtraction-side calibration measurement step S42 after setting the new X-axis reference calibration value Cx includes a step for calculating the new X-axis subtraction-side provisional calibration value Csx, in the same manner as in the addition-side calibration measurement step S41 (refer to steps S421 to S423).

In the present embodiment, in the subtraction-side calibration measurement step S42 in which the new X-axis reference calibration value Cx is set, the control device 12 calculates the new X-axis subtraction-side provisional calibration value Csx that is proportional to the difference between the target X-axis coordinate Ptx and the X-axis addition-side calibration measurement coordinate Pmax or the X-axis subtraction-side calibration measurement coordinate Pmsx of the Y-axis table 8 calculated when the new X-axis reference calibration value Cx was set. The control device 12 outputs, to the X-axis moving device 2, the new calibrated X-axis position control signal Sxc obtained by calibrating the X-axis position control signal Sx using the new X-axis subtraction-side provisional calibration value Csx (refer to steps S421 to S422).

The control device 12 measures, using the imaging device 10, the X-axis subtraction-side calibration measurement coordinate Pmsx of the Y-axis table 8 moved toward the target X-axis coordinate Ptx by the X-axis moving device 2, on the basis of the new calibrated X-axis position control signal Sxc (refer to step S423).

A second calibration step S43 of the second calibration control S4 includes a step for calculating the difference Da between the X-axis addition-side calibration measurement coordinate Pmax and the target X-axis coordinate Ptx and the difference Ds between the X-axis subtraction-side calibration measurement coordinate Pmsx and the target X-axis coordinate Ptx, and a step for setting, as the next new X-axis reference calibration value Cx, a provisional calibration value used for calculating the calibrated X-axis position control signal Sxc that moved the Y-axis table 8 to the calibration measurement coordinate (Pmax or Pmsx) whose calculated difference (Da or Ds) from the target X-axis coordinate Ptx is smaller, from among the calibration measurement coordinates Pmax and Pmsx (refer to steps S431 to S433).

With this configuration, the control device 12 sets the prescribed value for adding to or subtracting from the reference calibration value C to calculate the provisional calibration value, on the basis of the target position Pt and the measured position Pm. For example, when the difference between the target position Pt and the measured position Pm is relatively large (larger than a threshold value, for example), the control device 12 increases the prescribed value. That is, when the error between the reference calibration value C and the true calibration value Ct is large (larger than a threshold value, for example), the control device 12 increases the addition-side provisional calibration value Ca and the subtraction-side provisional calibration value Cs with respect to the reference calibration value C. Therefore, the control device 12 can swiftly bring the reference calibration value C closer to the true calibration value Ct. In addition, when the difference between the target position Pt and the measured position Pm is relatively small (smaller than a threshold value, for example), the control device 12 decreases the prescribed value. That is, when the error between the reference calibration value C and the true calibration value Ct is small (smaller than a threshold value, for example), the control device 12 decreases the setting values of the addition-side provisional calibration value Ca and the subtraction-side provisional calibration value Cs with respect to the reference calibration value C. Therefore, the reference calibration value C can be precisely brought closer to the true calibration value Ct.

For example, when positioning a chip with respect to a substrate, the positioning device 1 can bring the reference calibration value C closer to the true calibration value Ct to thereby suppress the error between the target position and the mounting position of the chip with respect to the substrate, thereby enabling a more accurate alignment. It is thereby possible to suppress the effect of calibration errors on the positioning accuracy, without using an electric actuator and an imaging unit 10 having higher accuracy.

### OTHER EMBODIMENTS

In the first embodiment described above, the positioning device 1 calculates the difference Da between the X-axis addition-side calibration measurement coordinate Pmax and the target X-axis coordinate Ptx, and the difference Ds between the X-axis subtraction-side calibration measurement coordinate Pmsx and the target X-axis coordinate Ptx. Furthermore, when the difference Da or the difference Ds is within a prescribed range, the positioning device 1 sets a new X-axis reference calibration value Cx and ends the second calibration control S2. However, if the difference between the target coordinate and the measured coordinate is within a prescribed range in the first calibration control, the positioning device may calculate the reference calibration value on the basis of the target coordinate and the measured coordinate and not carry out the second calibration control.

In addition, in all of the embodiments described above, the positioning device 1 repeats the second calibration control S2 until the difference Da or the difference Ds falls within a prescribed range. However, the positioning device may end the second calibration control S2 even if neither the difference Da nor the difference Ds falls within the prescribed range. The positioning device may end the second calibration control S2 on the condition that the second calibration control S2 has been repeated for a given number of times, for example.

In addition, in all of the embodiments described above, the positioning devices 1, 1A, 1B are configured to be capable of moving a target object to be positioned using the X-axis moving device 2 and the Y-axis moving device 6. However, it is sufficient if the positioning device includes at least one drive device. The positioning device may be configured to move a target object to be positioned using one drive device, or be configured to move the target object to be positioned using three or more of the drive devices.

In addition, in all of the embodiments described above, the positioning devices 1, 1A, 1B can use the calibrated position control signal Sc obtained by calibrating the reference calibration value C using the addition-side provisional calibration value Ca or the subtraction-side provisional calibration value Cs to bring the X-axis reference calibration value Cx and the Y-axis reference calibration value Cy closer to the true calibration value Ct. In addition, the positioning device is capable of calibrating a rotation reference calibration value calculated by a known method using an addition-side provisional calibration value and a subtraction-side provisional calibration value with respect to rotations around the X-axis, around the Y-axis, and around the Z-axis. The positioning device can use a position control signal calibrated using the addition-side provisional calibration value and the subtraction-side provisional calibration value to bring the Z-axis reference calibration value, the rotation reference value of each axis, and the rotational center reference calibration value of each axis closer to the true calibration value Ct.

In addition, in all of the embodiments described above, the positioning devices 1, 1A, 1B carry out positioning at a constant environmental temperature. However, the positioning device may have a correction formula or a correction table corresponding to various environmental temperatures in which a target object to be positioned is moved. The positioning device can update the reference calibration value with higher accuracy in consideration of the effects of environmental temperature.

In addition, in all of the embodiments described above, the X-axis moving device 2 of the positioning device 1 moves the target object to be positioned with the X-axis linear motor 3, which is an electric actuator. In addition, the Y-axis moving device 6 moves a target object to be positioned with the Y-axis linear motor 7, which is an electric actuator. However, the X-axis moving device and the Y-axis moving device may be composed of an electric actuator, such as a servo motor, and a linear motion device, such as a ball screw.

In addition, in all of the embodiments described above, the X-axis moving device 2 and the Y-axis moving device 6 have the X-axis scale 5 and the Y-axis scale 9, which are optical linear scales. However, the X-axis moving device and the Y-axis moving device may include magnetic linear scales, or optical/magnetic rotary encoder encoders, as long as the position of a movable element can be measured.

Embodiments of the present disclosure have been described above, but the embodiments described above are merely examples for implementing the present invention. Therefore, the present invention is not limited to the embodiments described above, and may be implemented by modifying the embodiments described above as appropriate to the extent of not departing from the essence of the present invention.

1. A positioning device comprising:
a target object moving unit having at least one electric actuator that is configured to move a target object;
a target object position measuring unit configured to measure a moved position of the target object; and
a control unit
configured to output, to the target object moving unit, a position control signal for moving the target object toward a target position, and
configured to acquire a measured position of the target object measured by the target object position measuring unit,
the control unit being configured to carry out
a first calibration control for calculating a reference calibration value of the position control signal on the basis of the target position and the measured position, and
a second calibration control for
outputting, to the target object moving unit, a calibrated position control signal obtained by calibrating the position control signal using an addition-side provisional calibration value obtained by adding a prescribed value to the reference calibration value, and acquiring, from the target object position measuring unit, an addition-side calibration measurement position obtained by measuring the moved position of the target object moved by the target object moving unit on the basis of the calibrated position control signal,
outputting, to the target object moving unit, a calibrated position control signal obtained by calibrating the position control signal using a subtraction-side provisional calibration value obtained by subtracting a prescribed value from the reference calibration value, and acquiring, from the target object position measuring unit, a subtraction-side calibration measurement position obtained by measuring the moved position of the target object moved by the target object moving unit on the basis of the calibrated position control signal, and
selecting, from the addition-side calibration measurement position and the subtraction-side calibration measurement position, a calibration measurement position that has a smaller difference from the target position, and setting, as a new reference calibration value, a provisional calibration value used for calculation of a calibrated position control signal that moved the target object to the selected calibration measurement position.

2. The positioning device according to claim 1, wherein
the control unit is configured to carry out the second calibration control on the basis of the new reference calibration value set in the second calibration control while a difference between the addition-side calibration measurement position and the target position or a difference between the subtraction-side calibration measurement position and the target position is not included in a prescribed range in the second calibration control.

3. The positioning device according to claim 1, wherein
the control unit is configured to carry out the second calibration control by
respectively outputting, to the target object moving unit, a plurality of calibrated position control signals obtained by calibrating the position control signal using a plurality of different addition-side provisional calibration values, and acquiring, from the target object position measuring unit, a plurality of addition-side calibration measurement positions obtained by measuring respective moved positions of the target object moved by the target object moving unit,
respectively outputting, to the target object moving unit, a plurality of calibrated position control signals obtained by calibrating the position control signal using a plurality of different subtraction-side provisional calibration values, and acquiring, from the target object position measuring unit, a plurality of subtraction-side calibration measurement positions obtained by measuring respective moved positions of the target object moved by the target object moving unit, and
setting, as the new reference calibration value, a provisional calibration value used for calculation of a calibrated position control signal that moved the target object to a calibration measurement position that has a smallest difference from the target position, from among the plurality of addition-side calibration measurement positions and the plurality of subtraction-side calibration measurement positions.

4. The positioning device according to claim 2, wherein
in response to the new reference calibration value being set in the second calibration control, the control unit is configured to
output, to the target object moving unit, a calibrated position control signal obtained by calibrating the position control signal using the addition-side provisional calibration value or the subtraction-side provisional calibration value that has been set as the new reference calibration value, and
calculate a new addition-side provisional calibration value and subtraction-side provisional calibration value on the basis of a difference between the target position and the addition-side calibration measurement position or the subtraction-side calibration measurement position while the target object moving unit moves the target object toward the target position on the basis of the calibrated position control signal.

5. The positioning device according to claim 1, wherein
the target object moving unit has at least one of an X-axis electric actuator that is configured to move the target object in an X-axis direction, a Y-axis electric actuator that is configured to move the target object in a Y-axis direction perpendicular to the X-axis direction, a Z-axis electric actuator that is configured to move the target object in a Z-axis direction that is perpendicular to the X-axis direction and the Y-axis direction, and an electric actuator that is configured to rotate the target object around an axis along one of the X-axis direction, the Y-axis direction, and the Z-axis direction.

6. A calibration method of a target object moving unit that has at least one electric actuator that is configured to move a target object, the calibration method comprising:
calculating a reference calibration value of a position control signal on the basis of a target position and a measured position of the target object;
outputting, to the target object moving unit, a calibrated position control signal obtained by calibrating the position control signal using an addition-side provisional calibration value obtained by adding a prescribed value to the reference calibration value, and measuring an addition-side calibration measurement position of the target object moved by the target object moving unit on the basis of the calibrated position control signal;
outputting, to the target object moving unit, a calibrated position control signal obtained by calibrating the position control signal using a subtraction-side provisional calibration value obtained by subtracting a prescribed value from the reference calibration value, and measuring a subtraction-side calibration measurement position of the target object moved by the target object moving unit on the basis of the calibrated position control signal; and
setting, as a new reference calibration value, a provisional calibration value used for calculation of a calibrated position control signal that moved the target object to a calibration measurement position that has a smaller difference from the target position, from among the addition-side calibration measurement position and the subtraction-side calibration measurement position.

7. The positioning device according to claim 2, wherein
the control unit is configured to carry out the second calibration control by
respectively outputting, to the target object moving unit, a plurality of calibrated position control signals obtained by calibrating the position control signal using a plurality of different addition-side provisional calibration values, and acquiring, from the target object position measuring unit, a plurality of addition-side calibration measurement positions obtained by measuring respective moved positions of the target object moved by the target object moving unit,
respectively outputting, to the target object moving unit, a plurality of calibrated position control signals obtained by calibrating the position control signal using a plurality of different subtraction-side provisional calibration values, and acquiring, from the target object position measuring unit, a plurality of subtraction-side calibration measurement positions obtained by measuring respective moved positions of the target object moved by the target object moving unit, and
setting, as the new reference calibration value, a provisional calibration value used for calculation of a calibrated position control signal that moved the target object to a calibration measurement position that has a smallest difference from the target position, from among the plurality of addition-side calibration measurement positions and the plurality of subtraction-side calibration measurement positions.

8. The positioning device according to claim 2, wherein
the target object moving unit has at least one of an X-axis electric actuator that is configured to move the target object in an X-axis direction, a Y-axis electric actuator that is configured to move the target object in a Y-axis direction perpendicular to the X-axis direction, a Z-axis electric actuator that is configured to move the target object in a Z-axis direction that is perpendicular to the X-axis direction and the Y-axis direction, and an electric actuator that is configured to rotate the target object around an axis along one of the X-axis direction, the Y-axis direction, and the Z-axis direction.
